(19) United States
(12) Patent Application Publication
(10) Pub. No.: US 2019/0051448 A1
(43) Pub. Date: Feb. 14, 2019

(54) INDUCTOR AND INDUCTOR ARRANGEMENT

(71) Applicant: Würth Elektronik eiSos GmbH & Co. KG, Waldenburg (DE)

(72) Inventor: Ranjith BRAMANPALLI, Waldenburg (DE)

(21) Appl. No.: 16/058,159

(22) Filed: Aug. 8, 2018

(30) Foreign Application Priority Data
Aug. 9, 2017 (EP) 17 185 444.1

(51) Int. Cl. H01F 27/28; H01F 27/40; H01F 27/29

(52) U.S. Cl. CPC H01F 27/289; H01F 27/29; H01F 27/40

(57) ABSTRACT

An inductor comprises an excitation coil with an excitation coil axis and at least one shielding coil with a respective shielding coil axis. The excitation coil axis and the shielding coil axis define an angle δ, wherein applies: 60°≤δ≤120°, preferably 75°≤δ≤105°, and preferably 85°≤δ≤95°. The inductor is shielded and enables in an easy and flexible manner the attenuation of electric and magnetic fields.

### CROSS-REFERENCES TO RELATED APPLICATIONS

This application claims the priority of European patent application, Serial No. 17 185 444.1, filed Aug. 9, 2017, pursuant to 35 U.S.C. 119(1)-(d), the content of which is incorporated herein by reference in its entirety as if fully set forth herein.

### FIELD OF THE INVENTION

The invention relates to an inductor and an inductor arrangement comprising such an inductor.

### BACKGROUND OF THE INVENTION

Achieving electromagnetic compatibility is a challenging task, since switching frequencies and transition times in switched-mode power supplies (SMPS) are increasing. Due to switching actions in switched-mode power supplies electric and magnetic fields are generated by inductors. To prevent excessive radiation of these fields, inductors are generally shielded.

U.S. Pat. No. 6,262,870 B1 discloses a switched power supply with a switching element that is connected to a switching transformer. The switching transformer comprises an annular ring which surrounds the transformer and is formed with an electrically conductive material. The annular ring suppresses or eliminates electrostatic interference caused by the structure and operation of the transformer.

### SUMMARY OF THE INVENTION

It is an object of the present invention to provide an inductor that enables in an easy and flexible manner the attenuation of electric and magnetic fields. Preferably, it is an object of the present invention to provide an inductor that efficiently reduces the near field radiation and has a high shielding effectiveness.

This object is achieved by an inductor comprising
an excitation coil with an excitation coil axis,
at least one shielding coil with a respective shielding coil axis, in which the at least one shielding coil surrounds the excitation coil, in which the excitation coil is arranged in a shielding coil interior of the at least one shielding,

in which the at least one shielding coil extends through an excitation coil interior of the excitation coil,

and in which the excitation coil axis and the respective shielding coil axis (11; 11, 14) define an angle δ, wherein applies: 60°≤δ≤120°, preferably 75°≤δ≤105°, and preferably 85°≤δ≤95°.

The electric and magnetic radiation of the excitation coil can be reduced in an easy and flexible manner by arranging the at least one shielding coil such that the angle δ between the excitation coil axis and the respective shielding coil axis is in the range of 60°≤δ≤120°, preferably 75°≤δ≤105°, and preferably 85°≤δ≤95°. Preferably, the angle δ is 90°. The excitation coil axis is a longitudinal axis of the excitation coil, whereas the shielding coil axis is a longitudinal axis of the associated shielding coil. The excitation coil produces a magnetic field (H-field) which produces according to the Maxwell-Faraday equation an electric field (E-field) in perpendicular direction of the magnetic field and vice versa. Due to the angle δ the at least one shielding coil efficiently suppresses the radiation of E-field and in consequence also the radiation of H-field. The inventive inductor has a high shielding effectiveness and enables the reduction of near field radiation. The shielding effectiveness can be adapted in an easy and flexible manner to a desired frequency by the number of shielding coils and/or the number of shielding coil layers and/or the diameter of the shielding coil wire. Preferably, the inductor has exactly one shielding coil. Due to the reduced component level radiation the inventive inductor is advantageously applicable in automotive applications.

Depending on a first pitch angle φ_{E} of excitation coil windings of the excitation coil and a respective second pitch angle φₛ of the at least one shielding coil, the excitation coil windings and the respective shielding coil windings define an angle α, wherein applies: 30°≤α≤150°, preferably 45°≤α≤135°, and preferably 60°≤α≤120°. Preferably, the angle α is 90°.

The inductor enables in an easy and flexible manner the attenuation of electric and magnetic fields. By surrounding the excitation coil the at least one shielding coil effectively shields electric and magnetic fields in many different directions. At least one shielding coil winding surrounds all excitation coil windings. The at least one shielding coil defines a respective shielding coil interior. The shielding coil interior is limited by the shielding coil windings. The excitation coil is arranged at least partially in the shielding coil interior such that the shielding coil windings run around the excitation coil. The excitation coil defines an excitation coil interior. The excitation coil windings limit the excitation coil interior. By extending through the excitation coil interior the at least one shielding coil surrounds the excitation coil and effectively shields electric and magnetic fields. The shielding coil windings surround the excitation coil and thereby extend through the excitation coil interior.

An inductor, in which the angle δ is defined in a projection plane, which preferably runs in parallel to the excitation coil axis, enables in an easy and flexible manner the attenuation of electric and magnetic fields. The angle δ ensures an exact positioning of the at least one shielding coil in relation to the excitation coil. Preferably, the angle a is also defined in the projection plane.

An inductor, in which the excitation coil is a solenoid and the excitation coil axis is a straight line, enables in an easy manner the attenuation of electric and magnetic fields. Since the excitation coil axis is a straight line the at least one shielding coil can easily be positioned such that the respective shielding coil axis encloses the angle δ with the excitation coil axis.

An inductor, in which the respective shielding coil axis is a curved line and surrounds the excitation coil axis at least partially, enables in an easy and flexible manner the attenuation of electric and magnetic fields. Since the at least one shielding coil is designed such that the respective shielding coil axis is a curved line that surrounds the excitation coil axis at least partially, the electric and magnetic field radiation of the excitation coil can be shielded in many different directions. Therefore, the shielding effectiveness is high.

An inductor, in which the at least one shielding coil is a toroid and the respective shielding coil axis is a circular arc, efficiently reduces the radiation of electric and magnetic fields. Since the at least one shielding coil is a toroid the excitation coil is surrounded by the at least one shielding coil and electric and magnetic fields are shielded in many different directions. Therefore, the shielding effectiveness is high.

An inductor, in which the at least one shielding coil has shielding coil windings which have an oval shape, enables in an easy and flexible manner the attenuation of electric and magnetic fields. Due to the oval shape the shielding coil windings surround the excitation coil in an easy and flexible manner and the at least one shielding coil can be adapted to an axial length of the excitation coil. The shielding coil windings define the oval shape in a view along the respective shielding coil axis. Therefore, the at least one shielding coil efficiently reduces the radiation of electric and magnetic fields.

An inductor, in which a core is arranged in an excitation coil interior of the excitation coil and the at least one shielding coil extends between the core and the excitation coil, ensures a high shielding effectiveness. The at least one shielding coil extends between the core and the excitation coil such that the shielding coil windings surround the excitation coil and extend partially in the excitation coil interior. Despite of the core the at least one shielding coil enables the attenuation of electric and magnetic fields.

An inductor, in which the excitation coil and the respective shielding coil are fixed relative to each other by an insulating material, preferably by a resin, enables in an easy and flexible manner the attenuation of electric and magnetic fields. Due to the insulating material the excitation coil and the at least one shielding coil are fixed relative to each other with the desired angle δ. Preferably, the insulating material is a resin.

An inductor, in which the at least one shielding coil forms at least one shielding coil layer, wherein for a number N of the at least one shielding coil layer applies: 1≤N≤8, preferably 2≤N≤4, ensures in an easy and flexible manner the attenuation of electric and magnetic fields. The shielding effectiveness increases with the number N of shielding coil layers. Furthermore, the number N of shielding coil layers can be adapted to a desired range of frequency. Preferably, the at least one shielding coil has a shielding coil wire with a diameter d, wherein applies: 0.01 mm≤d≤3.2 mm, preferably 0.04 mm≤d≤1.0 mm, preferably 0.06 mm≤d≤0.6 mm, preferably 0.09 mm≤d≤0.2 mm.

In a first embodiment the inductor has exactly one shielding coil that comprises at least one shielding coil layer. In a second embodiment the inductor has at least two shielding coils, wherein each shielding coil has at least one shielding coil layer. The at least two shielding coils have an equal number or a different number of shielding coil layers. Preferably, each shielding coil has exactly one shielding coil layer such that the number of shielding coils is equal to the number N of shielding coil layers.

An inductor, in which the excitation coil and the at least one shielding coil are encased by a metal enclosure, efficiently reduces the radiation of electric and magnetic fields. The metal enclosure improves the shielding effectiveness since electric and magnetic fields, preferably electric and magnetic fields caused by the at least one shielding coil, are effectively reduced.

Furthermore, it is an object of the invention to provide an inductor arrangement that enables in an easy and flexible manner the attenuation of electric and magnetic fields of an inductor.

This object is achieved by an inductor arrangement comprising
an inductor according to the invention,
a reference node,

wherein at least one pin of the at least one shielding coil is connected to the reference node. Each shielding coil has a first pin and a second pin. By connecting at least one pin of each shielding coil to the reference node the attenuation of electric and magnetic fields is effectively improved. The radiation of electric and magnetic fields caused by the excitation coil is effectively shielded by the at least one shielding coil. The first pin or the second pin or both pins of each shielding coil are connected to the reference node. For example, the reference node is a pin of the excitation coil or a base of the inductor arrangement. The reference node is preferably connected to ground. A pin of each shielding coil which is not connected to the reference node, is preferably not connected at all.

An inductor arrangement, in which the at least one pin is connected via a capacitor to the reference node, ensures the attenuation of electric and magnetic fields. By the capacitor the shielding effectiveness can be adapted to a desired range of frequency. For example, the first pin of the shielding coil is connected via a first capacitor to the reference node, whereas a second pin of the shielding coil is connected via a second capacitor to the reference node. By the capacitors the shielding effectiveness can be adapted to a desired frequency band.

Further features, advantages and details of the invention will be apparent from the following description of several embodiments which refer to the accompanying drawings.

### BRIEF DESCRIPTION OF THE DRAWINGS

FIG. 1 shows an inductor arrangement according to a first embodiment of the invention,

FIG. 2 shows a front view of an inductor in FIG. 1, but only with an excitation coil and a shielding coil and without a core and a metal enclosure,

FIG. 3 shows a top view of the inductor in FIG. 2,

FIG. 4 shows a schematic view of the positioning of the excitation coil and the shielding coil in FIG. 3,

FIG. 5 shows a diagram of an electric field strength E depending on a radial distance x from an excitation coil axis,

FIG. 6 shows a diagram of an attenuation A of the electric field depending on a frequency f and a diameter d of a shielding coil wire,

FIG. 7 shows an inductor arrangement according to a second embodiment of the invention,

FIG. 8 shows an inductor arrangement according to a third embodiment of the invention, wherein the shielding coil forms several shielding coil layers,

FIG. 9 shows an inductor arrangement according to a fourth embodiment of the invention with a first shielding coil and a second shielding coil, and

FIG. 10 shows a schematic view of the positioning of the excitation coil and the shielding coils in FIG. 9.

### DESCRIPTION OF THE PREFERRED EMBODIMENTS

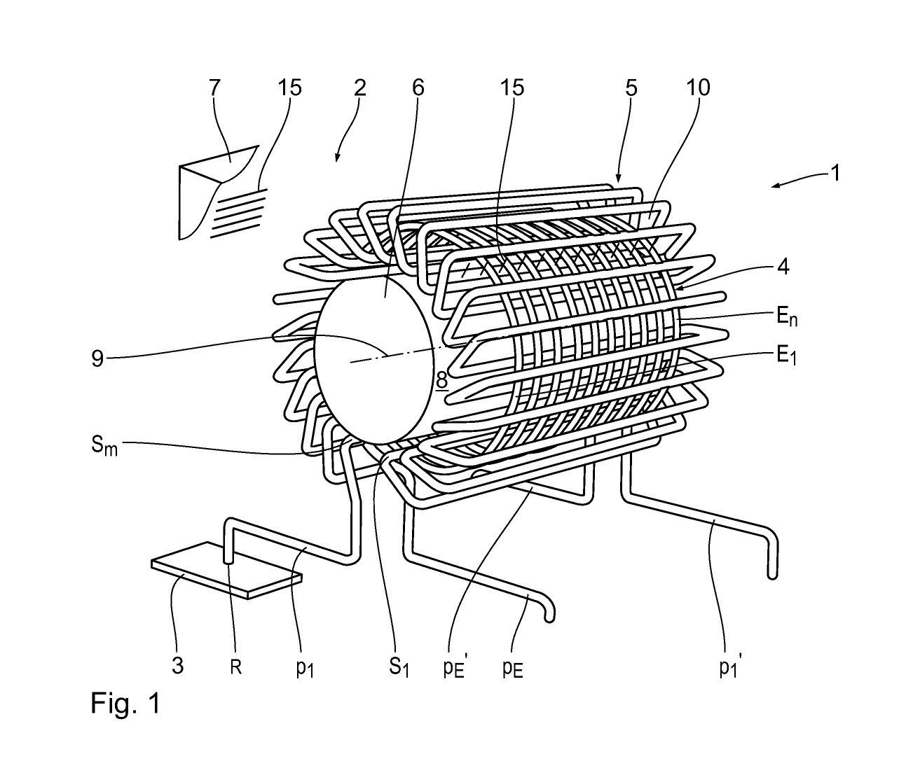

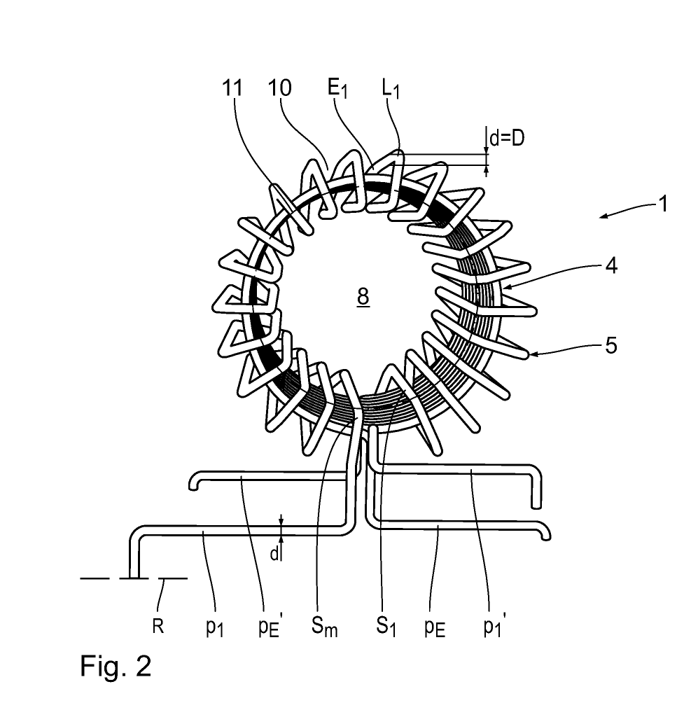

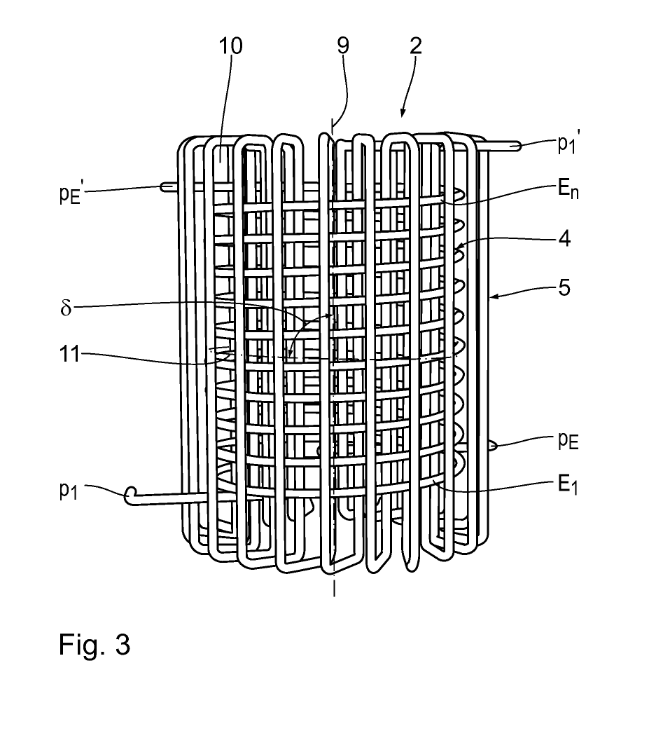

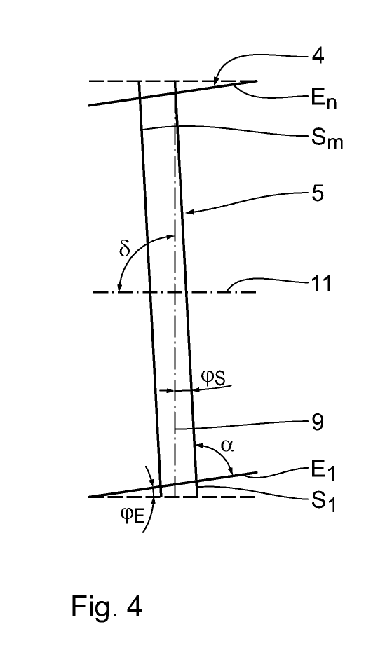

FIGS. 1 to 6 show a first embodiment of the invention. An inductor arrangement 1 comprises an inductor 2 and a reference node R which is formed by a metal base 3 and connected to ground. For example, the metal base 3 is connected to a chassis of a vehicle.

The inductor 2 comprises an excitation coil 4, a shielding coil 5, a magnetic core 6 and a metal enclosure 7. The metal enclosure 7 is shown in FIG. 1 merely partially.

The excitation coil 4 has several excitation coil windings E₁ to Eₙ which limit an excitation coil interior 8 and define an longitudinal excitation coil axis 9. N is the number of excitation coil windings. The excitation coil 4 is a solenoid. The associated excitation coil axis 9 is arranged concentrically in the excitation coil interior 8 and has the shape of a straight line. The excitation coil 4 has a first pin p_{E} and a second pin p_{E}′.

25

The shielding coil 5 has several shielding coil windings S ₁ to Sₘ which limit a shielding coil interior 10 and define a curved longitudinal shielding coil axis 11. M is the number of shielding coil windings. The shielding coil 5 is a toroid and the shielding coil axis 11 has the shape of a circular arc. The shielding coil 5 surrounds the excitation coil 4 such that the excitation coil 4 is arranged in the shielding coil interior 10. Hence, the shielding coil axis 11 which is a curved line in the shape of a circular arc concentrically surrounds the excitation coil axis 9. Since the shielding coil 5 surrounds the excitation coil 4 the shielding coil windings S₁ to Sₘ extend through the excitation coil interior 8 and have an oval shape. The oval shape depends on an axial length of the excitation coil 4 and the number n of excitation coil windings E₁ to Eₙ. The shielding coil windings S₁ to Sₘ extend through the excitation coil interior 8 and are arranged in a radial direction between the magnetic core 6 and the excitation coil 4.

The excitation coil 4 and the shielding coil 5 define in a projection plane P an angle δ, wherein applies: 60°≤δ≤120°, preferably 75°≤δ≤105°, and preferably 85°≤δ≤95°. The protection plane P runs in parallel to the excitation coil axis 9. For example, the angle δ=90°. The angle δ describes a rotation or a rotational displacement between the excitation coil axis 9 and the shielding coil axis 11.

The excitation coil 4 has in relation to a plane which runs perpendicular to the excitation coil axis 9 a pitch angle φ_{E}, whereas the shielding coil 5 has in relation to a plane which runs perpendicular to the shielding coil axis 11 a pitch angle φₛ. Depending on the pitch angles φ_{E} and φₛ the excitation coil windings E₁ to Eₙ and the shielding coil windings S₁ to Sₘ define an angle α, wherein applies: 30°≤α≤150°, preferably 45°≤α≤135°, and preferably 60°≤α≤120°.

The shielding coil 5 has a first pin p₁ and a second pin p₁′. The first pin p₁ is connected to the reference node R, whereas the second pin p₁′ is not connected at all.

The excitation coil 4, the shielding coil 5, the magnetic coil 6 and the metal enclosure 7 are fixed relative to each other by an insulating material 15. The insulating material 15 is shown in FIG. 1 merely partially. For example, the insulating material 15 is resin which fixes the mentioned components by curing.

The shielding coil 5 forms exactly one shielding coil layer L₁. Therefore, for a number N of shielding coil layers applies: N=1. The shielding coil 5 has a shielding coil wire with a diameter d, wherein applies: 0.01 mm≤d≤3.2 mm, preferably 0.05 mm≤d≤1.0 mm, preferably 0.06 mm≤d≤0.6 mm, preferably 0.09 mm≤d≤0.2 mm

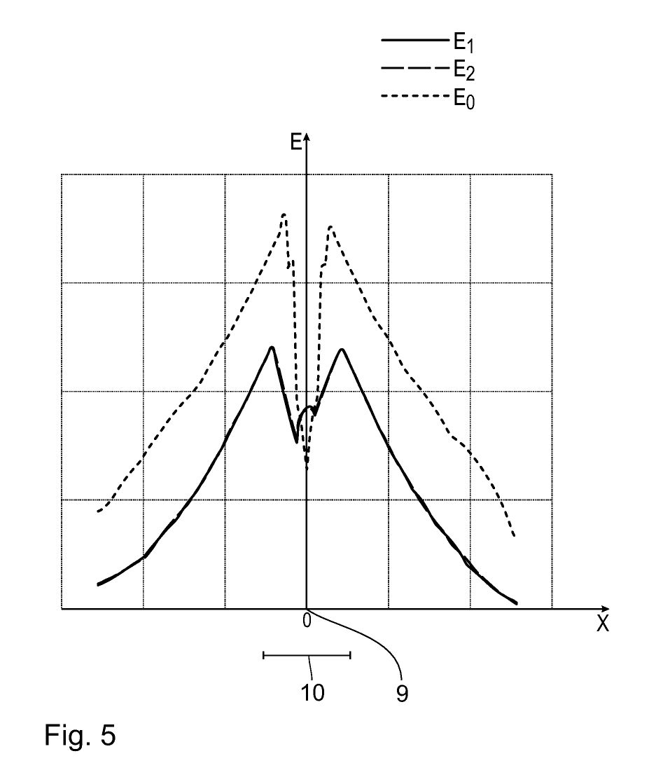

FIG. 5 shows the strength of the electric field (E-field) depending on the radial distance from the excitation coil axis 9. The x-coordinate is the radial distance from the excitation coil axis 9, whereas the y-coordinate is the strength of the electric field E. E₀ shows the strength of an electric field of the excitation coil 4 without the shielding coil 5. E₁ shows the strength of the electric field of the described inductor arrangement 1. E₂ shows the strength of the electric field in case that the second pin p₁′ is connected to the reference node R as well. The shielding coil 5 effectively reduces the radiation of the electric field and hence the radiation of the resulting magnetic field as well.

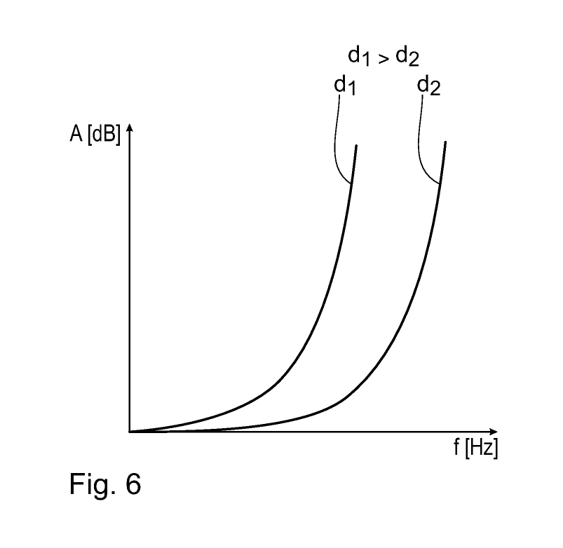

FIG. 6 shows a diagram of the attenuation A of the electric field depending on the frequency f for a first diameter d₁ of the shielding coil wire and a second diameter d₂ of the shielding coil wire, wherein d₁>d₂. For example, the shielding coil wire is of copper. A thickness D of the shielding coil layer L₁ is dependent on and equal to the diameter d of the shielding coil wire. The diameter d of the shielding coil wire is adapted to the desired attenuation A at a desired frequency f. When the desired attenuation frequency increases, the skin depth decreases. Hence, the diameter d of the shielding coil wire decreases as well.

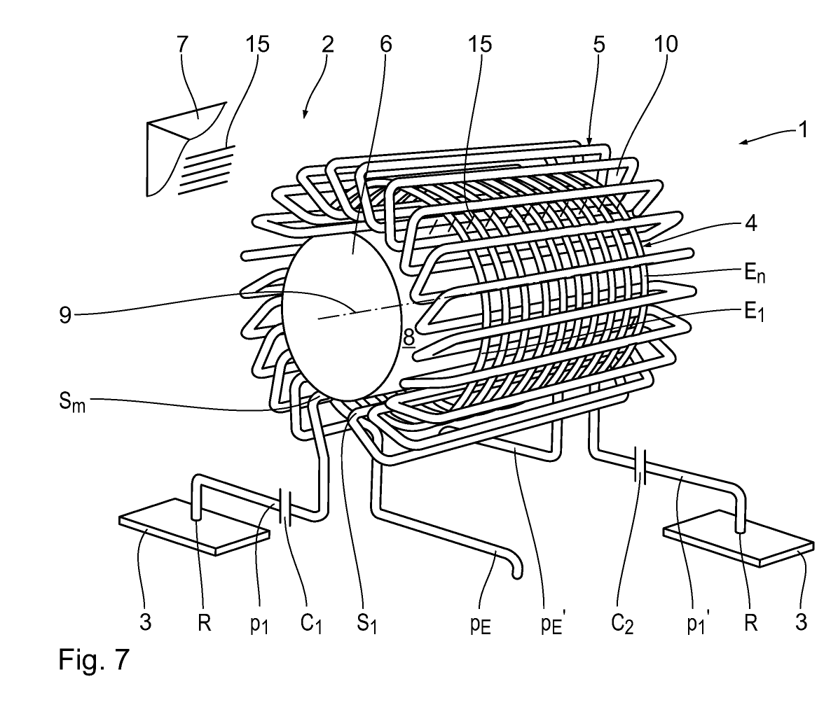

FIG. 7 shows an inductor arrangement according to a second embodiment of the invention. In difference to the first embodiment the first pin p₁ is connected via a first capacitor C₁ to the reference node R and the second pin p₁′ is connected via a second capacitor C₂ to the reference node R. The capacitors C₁ and C₂ enable to adapt the attenuation of electric and magnetic fields to a desired band of frequency. Further details concerning the design and functioning of the inductor arrangement 1 can be found in the description of the first embodiment.

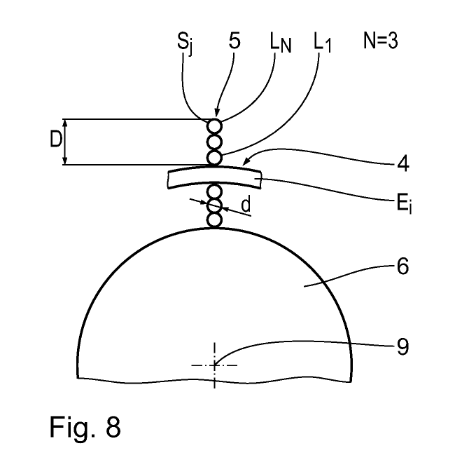

FIG. 8 shows an inductor arrangement 1 according to a third embodiment of the invention. In difference to the proceeding embodiments the shielding coil 5 has a number N=3 of shielding coil layers L₁ to L_{N}. The shielding coil layers L₁ to L_{N} form a thickness D which depends on the diameter d of the shielding coil wire and the number N. The number N of shielding coil layers L₁ to L_{N}, the thickness D of shielding coil layers L₁ to L_{N} and the diameter d of the shielding coil wire is adapted to the desired attenuation of electric and magnetic fields at a desired frequency. Eᵢ denotes one of the excitation coil windings E₁ to Eₙ, whereas Sⱼ denotes one of the shielding coil windings S₁ to Sₘ. Further details concerning the design and the functioning of the inductor arrangement 1 can be found in the descriptions of the proceeding embodiments.

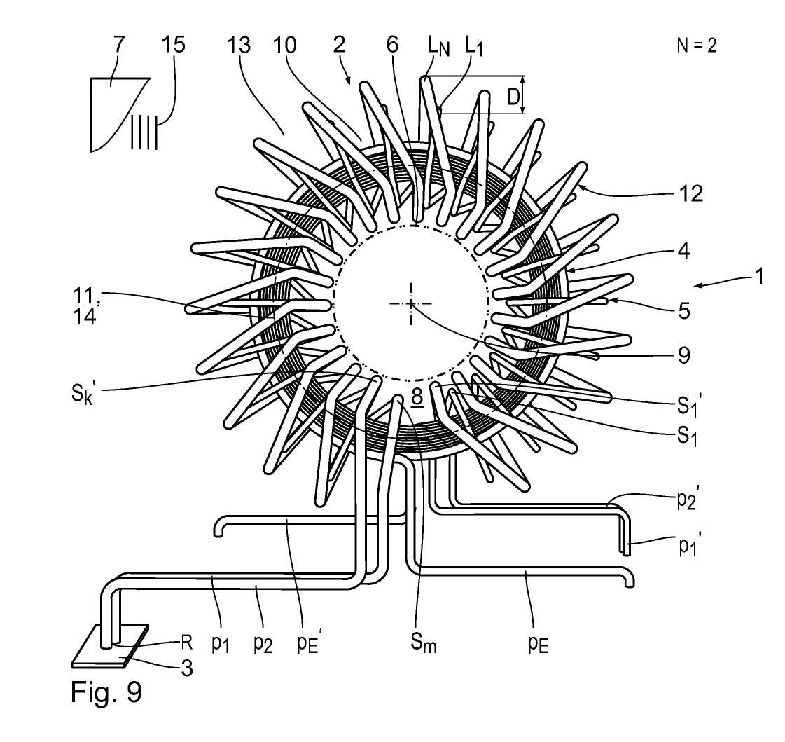

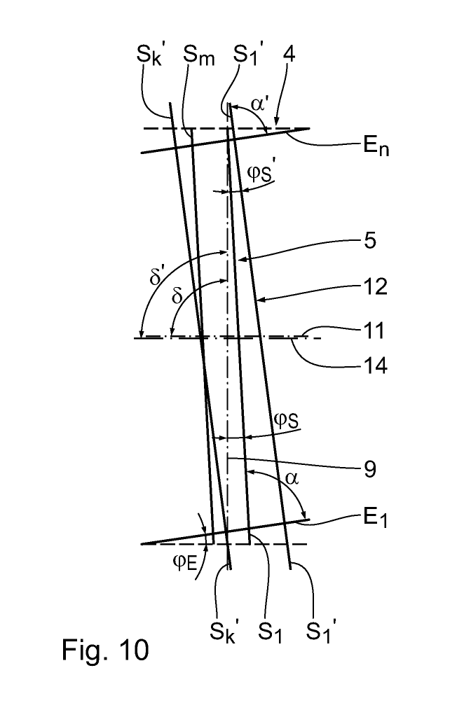

FIGS. 9 and 10 show an inductor arrangement 1 according to a fourth embodiment of the invention. In difference to the proceeding embodiments the inductor arrangement 1 comprises a first shielding coil 5 and a second shielding coil 12. The second shielding coil 12 has several shielding coil windings S₁′ to Sₖ′ which limit a second shielding coil interior 13 and define a second longitudinal shielding coil axis 14. The excitation coil 4 and the first shielding coil 5 are arranged in the second shielding coil interior 13. The second shielding coil 12 is a toroid and the second shielding coil axis 14 is a curved line in the shape of a circular arc which surrounds the excitation coil axis 11. The second shielding coil windings S₁′ to Sₖ′ extend through the excitation coil interior 8 and have an oval shape which depends on the axial length of the excitation coil 4.

The excitation coil axis 9 and the first shielding coil axis 11 define the angle δ, whereas the excitation coil axis 9 and the second shielding coil axis 14 define a corresponding angle δ′. For the angle δ′ applies as well: 60°≤δ≤′120°, preferably 75°≤δ′≤105°, and preferably 85°≤δ′≤95°. Preferably, δ=δ′ applies. The second shielding coil 12 has a second pitch angle φₛ′. The excitation coil windings E₁ to Eₙ and the second shielding coil windings S₁′ to Sₖ′ define an angle α′ which depends on the pitch angles φ_{E} and φₛ′. For the angle α′ applies: 30°≤α′≤150°, preferably 45°≤α′≤135°, and preferably 60°≤α′≤120°.

The shielding coils 5, 12 form a number N=2 of shielding coil layers L₁ to L_{N}. The first pin p₁ of the first shielding coil 5 and a first pin p₂ of the second shielding coil 12 are connected to the reference node R. The second pin p₁′ of the first shielding coil 5 and a second pin p₂′ of the second shielding coil 12 are not connected. Further details concerning the design and functioning of the inductor arrangement 1 can be found in the descriptions of the proceedings embodiments.

The features of the inductor arrangements 1 and the associated inductors 2 can be combined with one another as desired to achieve the desired attenuation of electric and magnetic fields at a desired frequency and the desired shielding effectiveness.

What is claimed is:

1. An inductor, comprising
an excitation coil with an excitation coil axis,
at least one shielding coil with a respective shielding coil axis,
wherein the at least one shielding coil surrounds the excitation coil,
wherein the excitation coil is arranged in a shielding coil interior of the at least one shielding coil,
wherein the at least one shielding coil extends through an excitation coil interior of the excitation coil,
wherein the excitation coil axis and the respective shielding coil axis define an angle δ, wherein applies: 60°≤δ≤120°.

2. An inductor according to claim 1, wherein
the angle δ is defined in a projection plane, which runs in parallel to the excitation coil axis.

3. An inductor according to claim 1, wherein
the excitation coil is a solenoid and the excitation coil axis is a straight line.

4. An inductor according to claim 1, wherein
the respective shielding coil axis is a curved line and surrounds the excitation coil axis at least partially.

5. An inductor according to claim 1, wherein
the at least one shielding coil is a toroid and the respective shielding coil axis is a circular arc.

6. An inductor according to claim 1, wherein
the at least one shielding coil has shielding coil windings which have an oval shape.

7. An inductor according to claim 1, wherein
a core is arranged in an excitation coil interior of the excitation coil and the at least one shielding coil extends between the core and the excitation coil.

8. An inductor according to claim 1, wherein
the excitation coil and the respective shielding coil are fixed relative to each other by an insulating material.

9. An inductor according to claim 1, wherein
the at least one shielding coil forms at least one shielding coil layer, wherein for a number N of the at least one shielding coil layer applies:
1≤N≤8.

10. An inductor according to claim 1, wherein
the excitation coil and the at least one shielding coil are encased by a metal enclosure.

11. An inductor arrangement, comprising
an inductor comprising
an excitation coil with an excitation coil axis,
at least one shielding coil with a respective shielding coil axis,
wherein the at least one shielding coil surrounds the excitation coil,
wherein the excitation coil is arranged in a shielding coil interior of the at least one shielding coil,
wherein the at least one shielding coil extends through an excitation coil interior of the excitation coil,
wherein the excitation coil axis and the respective shielding coil axis define an angle δ, wherein applies: 60°≤δ≤120°,
a reference node,
wherein at least one pin of the at least one shielding coil is connected to the reference node.

12. An inductor arrangement according to claim 11, wherein the at least one pin is connected via a capacitor to the reference node.
